(19) United States
(12) Patent Application Publication
(10) Pub. No.: US 2012/0162645 A1
(43) Pub. Date: Jun. 28, 2012

(54) METHOD FOR DETERMINING A MEASURED VARIABLE OF A MEDIUM, ESPECIALLY FOR TURBIDITY MEASUREMENT

(75) Inventors: Edin Andelic, Stuttgart (DE); Carsten Götz, Ettenheim (DE); Matthias Großmann, Vaihingen-Enz (DE)

(73) Assignee: Endress + Hauser Conducta Gesellschaft fur Mess- und Regeltechnik mbH + Co. KG, Gerlingen (DE)

(21) Appl. No.: 13/337,552

(22) Filed: Dec. 27, 2011

(30) Foreign Application Priority Data
Dec. 28, 2010 (DE) 10 2010 064 248.7

(51) Int. Cl. G01N 21/49

(52) U.S. Cl. 356/338

(57) ABSTRACT

Method for determining a measured value of a measured variable of a medium, by means of an optical sensor arrangement, which has at least one transmitter and at least one receiver, comprising the steps as follows: supplying the at least one transmitter with an exciter signal for producing an optical transmitter signal with a transmission signal strength, wherein the transmitter signal is converted by interaction with the medium as a function of the measured variable into a changed transmitter signal; producing a receiver signal from the transformed transmitter signal by means of the at least one receiver and registering a receiver signal strength of the receiver signal; conforming an excitation signal strength of the exciter signal based on the registered receiver signal strength for reaching a predetermined receiver signal strength; and registering the excitation signal strength required for reaching the predetermined receiver signal strength and determining the measured value therefrom.

The invention relates to a method for determining a measured variable of a medium, especially for turbidity measurement in a liquid or gaseous medium, by means of an optical sensor arrangement.

Such an optical sensor arrangement can comprise an apparatus for turbidity measurement for gaseous or liquid, measured media. In the following, the invention will be explained based on turbidity measurement. It is understood, however, that the principles of the invention can also be applied in the case of other optical measuring methods in analysis, especially in process measurements technology, in the case of which registerable changes of an optical transmitter signal result through the influence of the medium.

Turbidity arises in gases and liquids through the presence of dispersed materials. Turbidity can be determined based on the interaction between electromagnetic radiation and the measured medium, for example, by measuring the weakening of the intensity of radiation traversing through the medium (turbidimetry) or by measuring the intensity of the light scattered on the dispersed materials (nephelometry). In the case of nephelometry, the scattered light is measured at an angle, for example, 90°, to a measuring light beam radiated from an optical transmitter.

The term , “light” is, here and in the following, understood to mean not only electromagnetic radiation of the visible spectral region, but also electromagnetic radiation of any wavelength, especially also that in the infrared wavelength range.

It is, in this connection, known to use diodes as optical transmitter and as optical receiver. Used as optical transmitter in such case is a light-emitting diode for producing measuring light lying in a suitable wavelength range (e.g. infrared radiation between 800 and 1000 nm). The intensity of the light emitted from the light-emitting diode corresponds to the transmission signal strength. In turn, the receiver can be a photodiode, which produces from the received, scattered light a receiver signal, for example, a photocurrent or a photovoltage. The receiver signal strength, here the photocurrent strength, or the size of the photovoltage, depends on the intensity of the light impinging on the receiver diode, thus, in the case of turbidity measurement, on the intensity of the scattered light. This correlates, in turn, directly with the particle size and concentration of the scattering, dispersed materials, thus with the turbidity of the measured medium.

Frequently, the photocurrent, or the photovoltage, of the photodiode installed as receiver is integrated over a certain time span, the so-called integration time, and then converted, by an analog/digital converter connected downstream, into a digital signal. This digital signal can be fed to an electronic data processing system, for example, a microcomputer or microcontroller, which maps the digital signal, by means of a calibrated model stored in a memory of the data processing system, to a measured value of the measured variable to be determined.

Problematic is the choice of a suitable integration time. It must be selected differently for each measured medium. An integration time, which is too short, can lead in the case of certain media and turbidity values to a signal that is too weak. In the worst case, the signal can disappear in the quantization noise of the analog/digital converter. If, in contrast, the integration time is selected too long, in turn, the signal can be so strong that the analog/digital converter is driven into saturation and the measurement becomes unusable.

Known from DE 10 2008 010 446 A1 is a method for determining a measured variable of a medium, especially for turbidity measurement, in the case of which the measurement signal of a receiver of an optical measuring apparatus is integrated over a predetermined integration time, wherein the integration time or the transmission signal strength is predetermined as a function of the measurement signal strength. In this way, the measurement signal strength can be adjusted, for example, at the input region of the analog/digital converter, especially in such a manner that a saturation value of the analog/digital converter is not exceeded. If a suitable integration time or a suitable transmission signal strength is fixed, in the case of which the receiver signal produced by integration of the photocurrent or the photovoltage of the photodiode remains below the saturation of the analog/digital converter, the integrated and digitized receiver signal is used as measurement signal in the previously described manner for determining the measured variable, e.g. the turbidity.

An object of the invention is to provide a simplified method of the initially named type. Especially, the method should deliver reliable measured values independently of the selected integration time.

This object is achieved by a method as defined in claim 1. Other advantageous embodiments are set forth in the dependent claims.

The method for determining a measured value of a measured variable of a medium, especially for turbidity measurement in a liquid or gaseous medium, by means of an optical sensor arrangement, which has at least one transmitter and at least one receiver associated with the transmitter, includes steps as follows:

Supplying the at least one transmitter with an exciter signal for producing an optical transmitter signal with a transmission signal strength, wherein the transmitter signal is converted by interaction with the medium as a function of the measured variable into a changed transmitter signal;
producing a receiver signal from the transformed transmitter signal by means of the at least one receiver and registering a receiver signal strength of the receiver signal;
conforming an excitation signal strength of the exciter signal based on the registered receiver signal strength for reaching a predetermined receiver signal strength; and
registering the excitation signal strength required for reaching the predetermined receiver signal strength and determining the measured value therefrom.

The exciter signal can be actively controlled as a function of the registered receiver signal strength, so that the receiver signal strength is tuned to a predetermined value.

The at least one transmitter can comprise a light source, especially a light-emitting diode. The exciter signal can, in this case, be an operating voltage or an operating current of the light source, for example, the light-emitting diode. Through variation of the exciter signal, thus here the operating voltage, or the operating current, the transmission signal strength varies correspondingly, here thus the intensity of the radiation emitted by the light-emitting diode.

The at least one receiver can comprise at least one photoelectric element, especially a photodiode. The photoelectric element is matched with the transmitter, for example, a light-emitting diode, in such a manner that a transmitter signal emitted from the light-emitting diode, here a light signal, after interaction with the medium, is at least partially received by the photoelectric element and converted by such into an electrical signal, especially a photocurrent or a photovoltage.

In the case of an optical turbidity measurement, a transmitter signal emitted in the form of a measuring light beam from a light source serving as transmitter is scattered in the medium. The receiver, e.g. a photodiode, can be oriented, for example, in such a manner with reference to the light source that it receives the transmitter signal directly, thus upon exit, i.e. the measuring light beam, after passing through the medium, falls on the receiver. The receiver signal, e.g. the photocurrent of the photodiode, or a signal derived therefrom, is then a measure for the weakening of the transmitter signal caused by the interaction with the medium, especially the scattering on particles or gas bubbles of the medium.

Alternatively, the receiver for turbidity measurement can be so oriented relative to the transmitter that it receives radiation scattered in the medium. The interaction of the measuring light beam emitted from the light source with the medium in the form of scattering on particles or air bubbles in the medium leads to the occurrence of scattered radiation, which propagates with different intensity in all spatial directions. The receiver, e.g. a photoelectric element, such as e.g. a photodiode, for receipt of scattered radiation, is oriented, consequently, at an angle different from 0° and 180° relative to the measuring light beam, preferably at an angle of 90° or 135°. The receiver signal, e.g. the photocurrent of the photoelectric element, especially the photodiode, or a signal derived therefrom, is a measure for the scattered light intensity and therewith a measure for the turbidity of the medium.

The receiver signal can be a photocurrent dependent on light intensity received by the photoelectric element or a photovoltage dependent on light intensity impinging on the photoelectric element.

The receiver signal can also be produced by integration of a photocurrent dependent on light intensity received by the photoelectric element or a photovoltage dependent on light intensity impinging on the photoelectric element over a predetermined integration time.

The receiver signal, especially the receiver signal produced by an integration circuit by integration of the photocurrent or the photovoltage, can be converted by means of an analog/digital converter into a digital, receiver signal.

For adjusting or controlling the exciter signal, the digital receiver signal can be compared with a predetermined signal value, and, based on this comparison, the exciter signal can be tuned in such a manner that the receiver signal agrees with the predetermined signal value.

The invention will now be described in greater detail in the following based on the drawing.

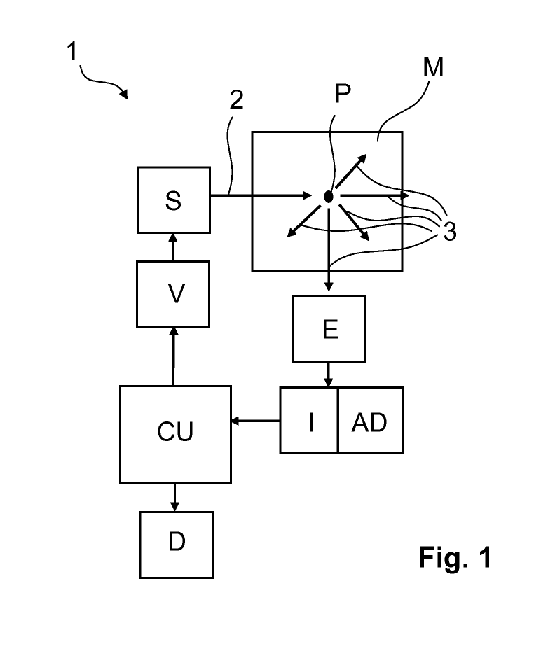

FIG. 1 shows a measuring system with an optical sensor arrangement with a light-emitting diode and a photodiode for turbidity measurement.

The measuring system 1 includes for the transmitter a light-emitting diode S, which is supplied with an operating current by means of a supply circuit V. The light-emitting diode S radiates measuring light 2 (whose intensity depends on the strength of the operating current) into a medium M, especially a liquid medium M, which contains scattering particle P, for example, solid particles or gas bubbles. In the medium M, by interaction between the measuring light 2 and the scattering particles P, scattered light 3 is emitted in all spatial directions. A photodiode E is so positioned, that it receives scattered light 3, which is scattered at an angle of 90° relative to the radiated measuring light beam 2. The photodiode E can, of course, also be arranged at some other angle relative to the measuring light beam 2. Photodiode E produces, as a function of the scattered light intensity received by it, an electrical signal, especially a photocurrent, or a photovoltage, whose signal intensity or signal strength depends on the scattered light intensity. The photocurrent or, correspondingly, the photovoltage is integrated via an integration circuit I with a capacitor for forming a receiver signal. The voltage applied to the capacitor is, in such case, converted by means of an analog/digital converter AD into a digital receiver signal. Connected with the analog/digital converter AD is a control unit CU, which receives the digitized receiver signal and further processes it.

The control unit CU can be formed by an electronic data processing system, for example, a microcomputer, which includes a microprocessor and, in given cases, one or more additional data memories. Stored in the microcomputer is a predetermined receiver signal value, with which the control unit CU compares the registered, digitized, receiver signal. For this, stored in the microcomputer is a comparison algorithm, through which a tolerance range is established around the predetermined receiver signal value. If CU the registered, digital, receiver signal falls in the tolerance range, such is taken to mean that there is agreement between the registered and the predetermined receiver signal values.

If, in contrast, the registered, digital, receiver signal deviates from the predetermined receiver signal so widely, that it no longer lies within the predetermined tolerance range, such is judged by the control unit CU to mean that a deviation has been detected. In this case, via a standard controller, such as a P-, PI-, PD- or PID controller, provided in the control unit CU and connected with the supply circuit V, the exciter signal, here the operating voltage, or the operating current, of the light-emitting diode S can be varied, until agreement is detected between the registered and the predetermined receiver signal values.

The control of the supply circuit can be implemented by a controller circuit or by software executable in the electronic data processing system of the control system CU. In the latter case, the data processing system determines from the deviation between the signal strength of the registered receiver signal and the predetermined receiver signal strength, based on the known transfer function of the measuring arrangement 1, the required supply voltage, or the required supply current for reaching the predetermined receiver signal strength and adjusts the supply current provided by the supply circuit of the light source E correspondingly.

The excitation signal strength, in the example shown here thus the supply current of the light-emitting diode E, leading to the registering of a receiver signal strength agreeing with the predetermined receiver signal strength, is registered as measurement signal. Based on a calibration function stored in a data memory of the control unit, the measurement signal is mapped to a turbidity measured value. This can be output on a display unit D. Alternatively, the measured value can be output to a superordinated unit, for example, to a measurement transmitter, or to a process control station.

The invention is especially well suited for measuring the solids content in a suspension of water and clarification mud. However, it is not limited to this field in the environmental sector. The invention can especially be applied advantageously anywhere where strong fluctuations of the measured variable, especially the turbidity, occur. That can generally be the case in measurements technology or in process technology. The invention can be applied advantageously in all these technical areas.

1-8. (canceled)

9. A method for determining a measured value of a measured variable of a medium, especially for turbidity measurement in a liquid or gaseous medium, by means of an optical sensor arrangement, which has at least one transmitter and at least one receiver associated with the transmitter, comprising the steps of:
supplying the at least one transmitter with an exciter signal for producing an optical transmitter signal with a transmission signal strength, wherein the transmitter signal is converted by interaction with the medium as a function of the measured variable into a changed transmitter signal;
producing a receiver signal from the transformed transmitter signal by means of the at least one receiver and registering a receiver signal strength of the receiver signal;
conforming an excitation signal strength of the exciter signal based on the registered receiver signal strength for reaching a predetermined receiver signal strength; and
registering the excitation signal strength required for reaching the predetermined receiver signal strength and determining the measured value therefrom.

10. The method as claimed in claim 9, wherein:
the exciter signal is controlled as a function of the registered receiver signal strength for reaching a predetermined value of the receiver signal strength.

11. The method as claimed in claim 9, wherein:
the at least one transmitter includes a light source, especially a light-emitting diode, and the exciter signal is an operating voltage or an operating current of the light source.

12. The method as claimed in claim 9, wherein:
the at least one receiver includes at least one photoelectric element, especially a photodiode.

13. The method as claimed in claim 12, wherein:
the receiver signal is a photocurrent dependent on a light intensity received by the photoelectric element or a photovoltage dependent on the light intensity impinging on the photoelectric element.

14. The method as claimed in claim 12, wherein:
the receiver signal is produced by integration of a photocurrent dependent on a light intensity received by the photoelectric element or a photovoltage dependent on the light intensity impinging on the photoelectric element over a predetermined integration time.

15. The method as claimed in claim 9, wherein:
the receiver signal is converted by means of an analog/digital converter into a digital receiver signal.

16. The method as claimed in claim 15, wherein:
for adjusting or controlling the exciter signal, the digital receiver signal is compared with a predetermined signal value, and, based on this comparison, the exciter signal is tuned in such a manner that the receiver signal agrees with the predetermined signal value.
